(19) United States
(12) Patent Application Publication
(10) Pub. No.: US 2004/0237391 A1
(43) Pub. Date: Dec. 2, 2004

(54) Simulated brick trim apparatus

(76) Inventors: Stephen English, Dillsburg, PA (US); Steven F. Brooker, Marietta, OH (US)

Correspondence Address: Brij K. Agarwal, Eckert Seamans Cherin & Mellott, LLC, 44th Floor, 600 Grant Street, Pittsburgh, PA, 15219, US

(21) Appl. No.: 10/447,474

(22) Filed: May 29, 2003

(51) Int. Cl. A01G 1/00

(52) U.S. Cl. 47/33

(57) ABSTRACT

An improved trim apparatus includes an edging member and a number of fasteners, the fasteners being structured to mount the edging member to a grade. The edging member includes a number of brick members that are aligned with one another to simulate bricks. The brick members are slightly tapered, which accentuates the appearance of individual bricks. The trim apparatus is configured such that the fasteners cannot be inserted incorrectly into the edging member, which facilitates attachment of the edging member to the grade. An exterior of the trim apparatus is textured to simulate aged brick.

### BACKGROUND OF THE INVENTION

1. Field of the Invention

The present invention relates generally to trim materials such as edging and, more particularly, relates to a simulated brick trim that can be mounted on a grade.

2. Description of the Related Art

Numerous types of lawn and garden trim materials are known in the relevant art. Such a trim material may, for instance, be employed to clearly define a border between a garden and a lawn. Numerous types of materials can be employed as aesthetically pleasing trim materials, such as bricks, railroad ties, stone, and strips of plastic, among other materials. As a general matter, for such trim materials to be effective they should remain in place after positioning, be rather resistant to the elements, and be aesthetically pleasing.

The expense and effort associated with the use of materials such as bricks, railroad ties, and stones often militate against their use. A need thus exists for an improved trim material that can be relatively easily used, both in terms of cost and effort required, that is aesthetically pleasing.

### SUMMARY OF THE INVENTION

An improved trim apparatus in accordance with the present invention meets and exceeds these and other needs. An improved trim apparatus includes an edging member and a number of fasteners, the fasteners being structured to mount the edging member to a grade. The edging member includes a number of brick members that are aligned with one another to simulate bricks. The brick members are slightly tapered, which accentuates the appearance of individual bricks. The trim apparatus is configured such that the fasteners cannot be inserted incorrectly into the edging member, which facilitates attachment of the edging member to the grade. An exterior of the trim apparatus is textured to simulate aged brick.

Accordingly, an aspect of the present invention is to provide an improved trim apparatus that is aesthetically pleasing and that can be used with relative ease.

Another aspect of the present invention is to provide an improved trim apparatus that simulates bricks.

Another aspect of the present invention is to provide an improved trim apparatus that can be mounted to a grade with relative ease.

Another aspect of the present invention is to provide an improved trim apparatus having a number of brick members, with the brick members being slightly tapered to accentuate the appearance of individual bricks.

Another aspect of the present invention is to provide an improved trim apparatus having an edging member that can be mounted to a grade with a number of fasteners, with the fasteners being incapable of incorrect insertion in order to facilitate installation of the trim apparatus.

Another aspect of the present invention is to provide an improved trim apparatus that is textured to simulate aged brick.

Another aspect of the present invention is to provide an improved trim apparatus that can be used cooperatively with other similar trim apparatuses.

Another aspect of the present invention is to provide an improved trim apparatus including an edging member and a number of fasteners, with the fasteners being configured to aesthetically cooperate with the exterior of the edging member.

Accordingly, an aspect of the present invention is to provide a trim apparatus structured to be mounted on a grade, in which the general nature of the trim apparatus can be stated as including an edging member including a receptacle formed therein, the edging member being structured to be disposed on the grade, and at least a first fastener. The at least first fastener includes an elongated shank and a head, at least a portion of the shank being receivable in the receptacle, and at least a portion of the shank is engageable with the grade to mount the trim apparatus on the grade, whereby at least a portion of the edging member is interposed between the head and the grade. The edging member includes one of a male engagement member and a female engagement member disposed on the receptacle, with the shank including the other of the male engagement member and the female engagement member, and with the male and female engagement members being cooperable with one another to align the shank in a given rotational orientation in the receptacle with respect to the edging member when at least a portion of the shank is received in the receptacle.

The edging member may include a plurality of brick members, with each brick member including a pair of opposed surfaces that are spaced apart from one another and are oriented slightly nonparallel with one another, whereby at a region of juncture between adjoining brick members the opposed surfaces of one adjoining brick member are spaced closer to one another than the pair of opposed surface of the other adjoining brick member. The trim apparatus may include texturing formed on at least a portion of the exterior thereof.

Another aspect of the present invention is to provide a trim apparatus structured to be mounted on a grade in which the general nature of the trim apparatus can be stated as including an edging member and at least a first fastener. The edging member includes a pair of member surfaces and a receptacle, and further includes a member surface joint formed generally by an intersection of the pair of member surfaces, with the receptacle being disposed generally at the member surface joint, and with the edging member being structured to be disposed on the grade. The at least first fastener includes an elongated shank and a head, with at least a portion of the at least first fastener being receivable in the receptacle, and with the at least first fastener received in the receptacle being engageable with the grade to retain the edging member on the grade. The head includes a pair of head surfaces that intersect with one another to form a head surface joint. The head surfaces are alignable substantially flush with the member surfaces, and the head surface joint is alignable substantially flush with the member surface joint, when at least a portion of the at least first fastener is received in the receptacle.

### BRIEF DESCRIPTION OF THE DRAWINGS

A further understanding of the invention can be gained from the following Description of the Preferred Embodiment when read in conjunction with the accompanying drawings in which:

FIG. 1 is a perspective view of a trim apparatus in accordance with the present invention;

FIG. 2 is another perspective of the trim apparatus;

FIG. 3 is a sectional view as taken along line 3-3 of FIG. 1;

FIG. 4 is a sectional view as taken along line 4-4 of FIG. 2;

FIG. 5 is a sectional view as taken along line 5-5 of FIG. 3;

FIG. 6 is a sectional view as taken along line 6-6 of FIG. 3;

FIG. 7 is a bottom plan view of an edging member of the trim apparatus;

FIG. 8 is a perspective view of a pair of the trim apparatuses disposed adjacent one another; and

FIG. 9 is a top plan view of the trim apparatus.

Similar numerals refer to similar parts throughout the specification.

### DESCRIPTION OF THE PREFERRED EMBODIMENT

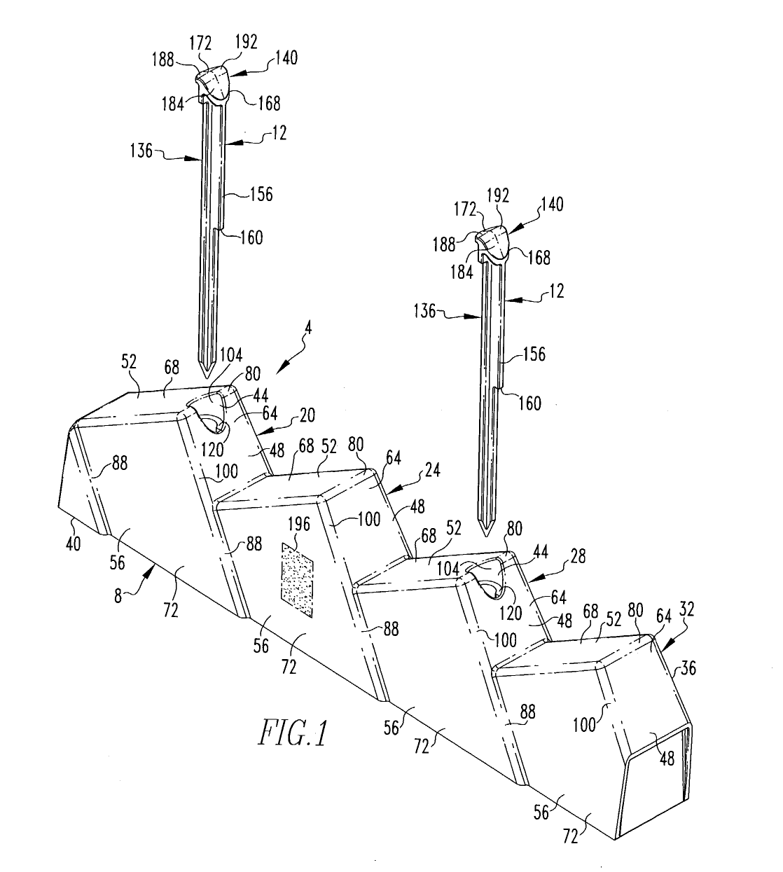

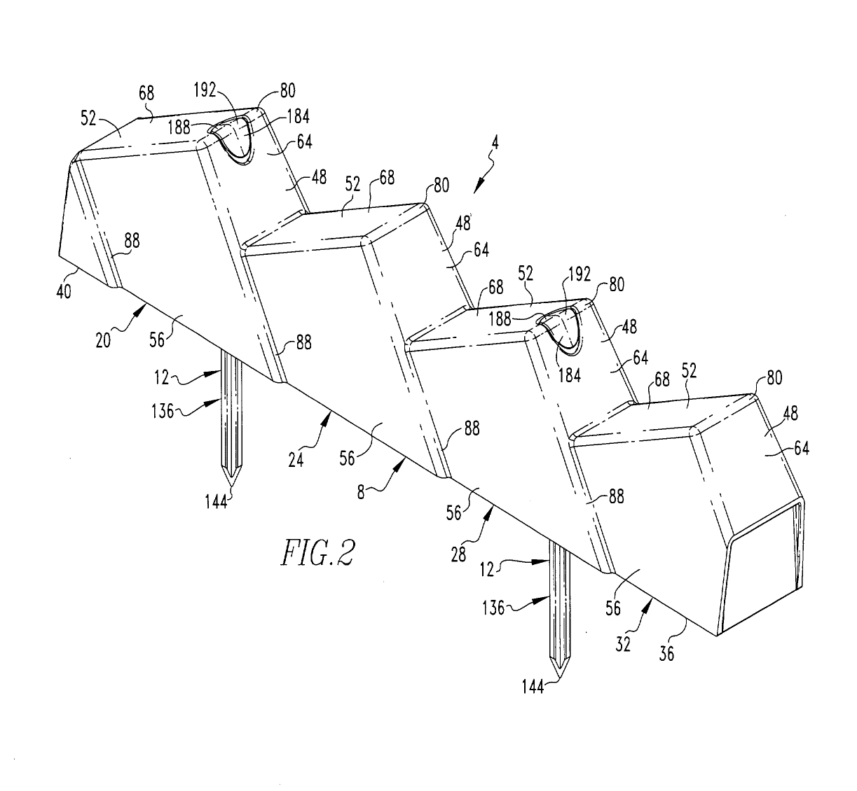

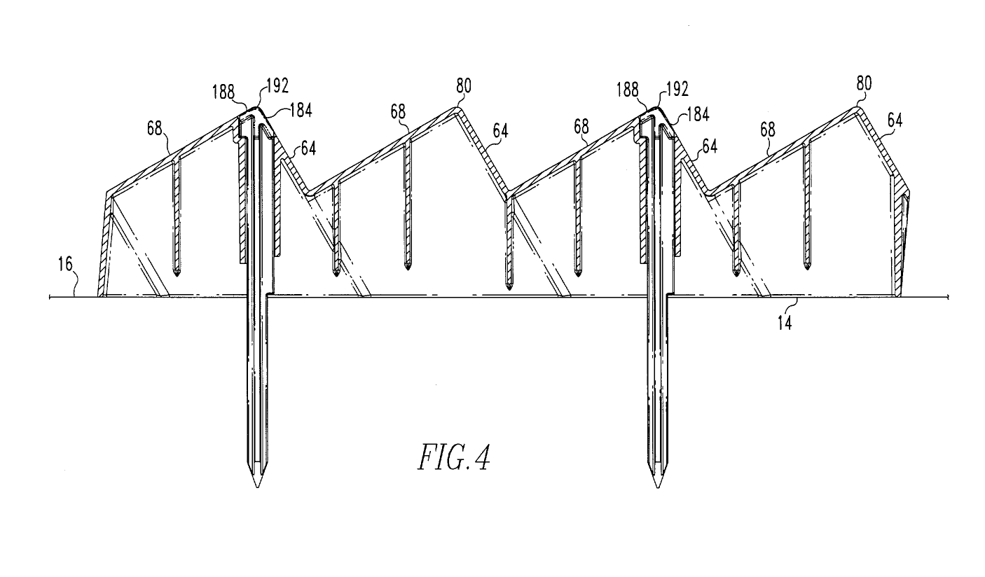

An improved trim apparatus 4 in accordance with the present invention is indicated generally FIGS. 1 and 2. The trim apparatus 4 can be mounted on a grade 16 (FIG. 4) for use in a trim or edging function, such as in lawn and garden applications and other applications. As will be set forth more fully below, the trim apparatus 4 can be easily mounted onto the grade 16, is aesthetically pleasing, and can be configured to be relatively resistant to the elements.

As is best shown in FIG. 1, the trim apparatus 4 includes an edging member 8 and a pair of fasteners 12. As is best shown in FIG. 4, the edging member 8 includes a base 14 defined thereon, and the edging member 8 can be mounted on the grade 16 by receiving the base 14 against the grade 16 and engaging the fasteners 12 with the grade 16. The trim apparatus 4 can be made of various plastic materials or other materials and thus can be configured to be lightweight, inexpensive, and resistant to the elements prevailing in the outdoors.

As can be seen in FIGS. 1, 2, 7, and 8, the edging member 8 includes a plurality of brick members, specifically, a brick member 20, a brick member 24, a brick member 28, and a brick member 32, aligned with one another and disposed serially adjacent one another. The brick members 20, 24, 28, and 32 simulate bricks that are angled with respect to the base 14, and when installed appear to be angled with respect to the grade 16.

The brick member 32 is actually divided into two parts, that is, the brick member 32 includes a relatively larger first portion 36 disposed adjacent the brick member 28 and a relatively smaller second portion 40 that is disposed adjacent the brick member 20. As can be understood from FIG. 8, the split configuration of the brick member 32 permits the trim apparatus 4 to be used cooperatively with other trim apparatuses 4 whereby the first portion 36 of one of the trim apparatuses 4 is disposed adjacent the second portion 40 of another of the trim apparatuses 4. In so doing, and as is indicated from FIG. 8, the first and second portions 36 and 40 disposed adjacent one another together simulate a brick that is angled with respect to the grade 16.

The brick members 20 and 28 each include a receptacle 44 formed therein. The fasteners 12 are receivable in the receptacles 44 for mounting the edging member 8 to the grade 16.

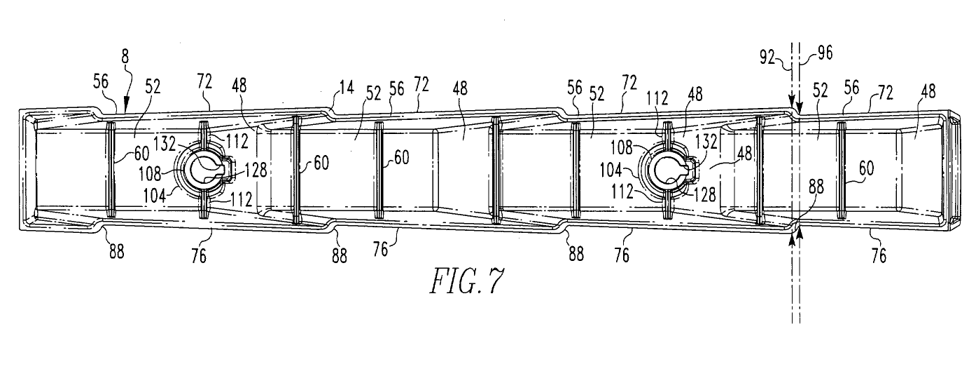

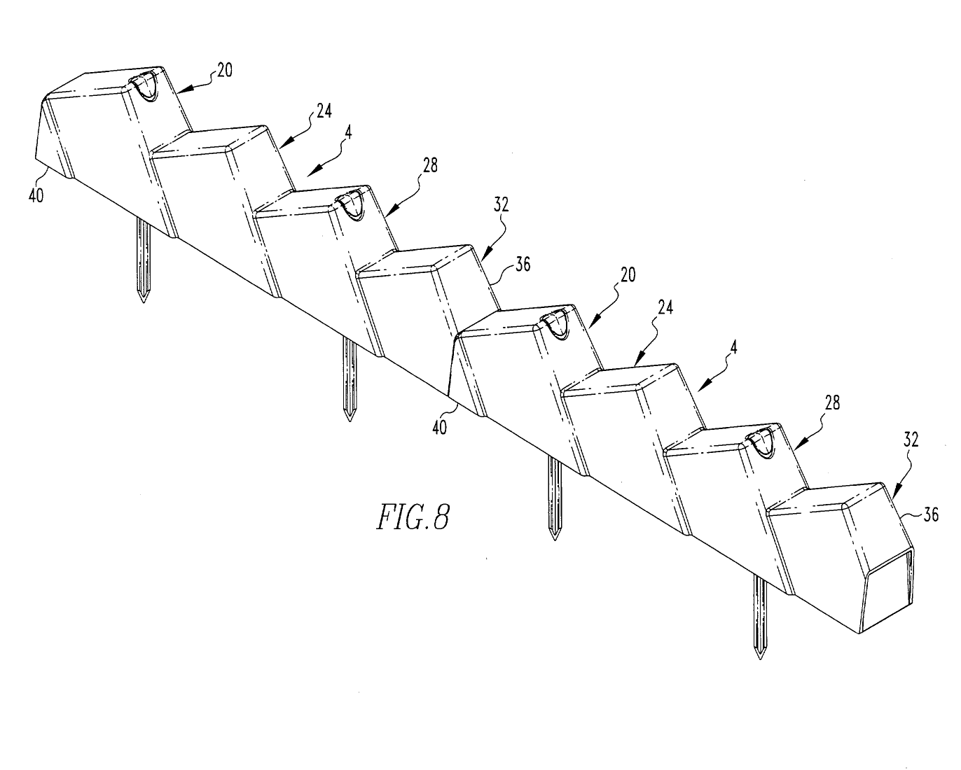

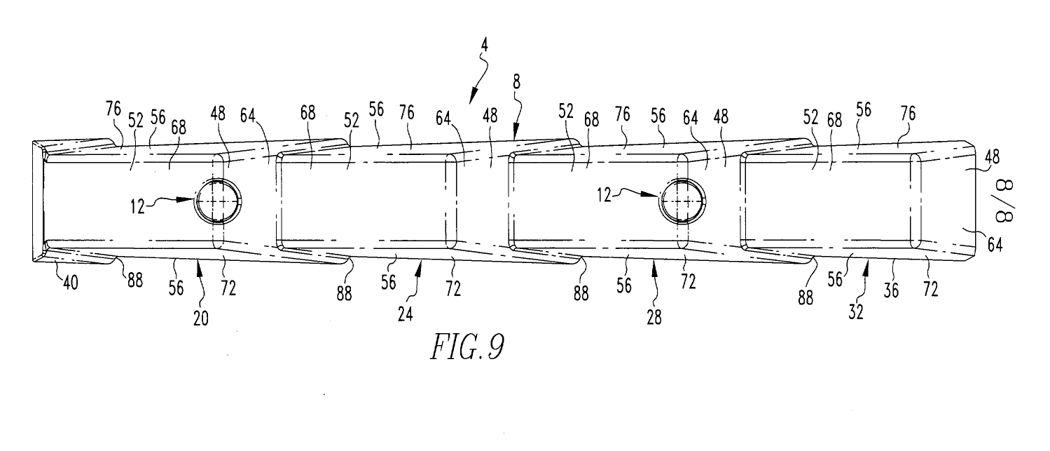

The brick members 20 and 28 each include a front plate 48, a rear plate 52, and a pair of side plates 56. As is shown generally in FIG. 7, a number of bracing members 60 extend between the side plate 56 to provide rigidity to the edging member 8.

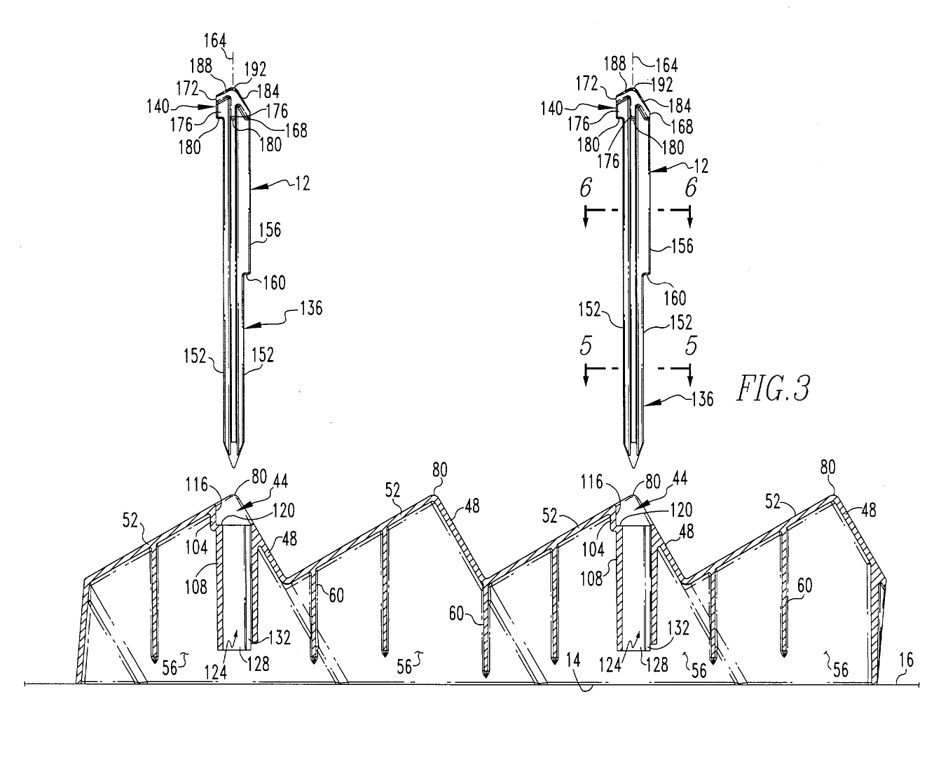

The front plate 48 includes a front surface 64 defined thereon. The rear plate 52 includes a rear surface 68 defined thereon. One of the side plates 56 includes a first side surface 72 defined thereon, and the other side plate 56 includes a second side surface 76 defined thereon. The front and rear surfaces 64 and 68 are oriented roughly perpendicular to one another and intersect one another at a radiused member surface joint 80. It can be understood from FIGS. 3 and 4 that the front and rear surfaces 64 and 68 are oriented at different angles with respect to the base 14 and thus to the grade 16. The receptacles 44 are disposed generally at the member surface joints 80.

The first and second side surfaces 72 and 76 are slightly nonparallel, meaning that they are nearly parallel and generally appear to be parallel but, in fact, are oriented at a slight angle with respect to one another. The slightly nonparallel orientation or tapering of the first and second side surfaces 72 and 76 with respect to one another accentuates the appearance that the brick members 20, 24, 28, and 32 are individual bricks. Specifically, a region of juncture 88 exists where adjacent brick members 20, 24, 28, and 32 connect with one another, that is, a region of juncture 88 exists between the brick members 20 and 24, another region of juncture 88 exists between the brick members 24 and 28, and yet another region of juncture 88 exists between the brick member 28 and the first portion 36 of the brick member 32. It can further be seen that still another region of juncture 88 exists between the brick member 20 and the second portion 40. At each of the regions of juncture 88, the first and second side surfaces 72 and 76 of one of the adjacent brick members are spaced slightly farther away from one another than the first and second side surfaces 72 and 76 of the other adjacent brick members.

Such a relationship is explicitly depicted in FIG. 7. On alternate sides of the region of juncture 88, the first and second side surfaces 72 and 76 of one of the adjacent brick members are spaced at a first width 92, and the first and second side surfaces 72 and 76 of the other adjacent brick member are spaced apart by a second width 96, with the first and second widths 92 and 96 being different. The tapered or slightly nonparallel orientation of the first and second sides 72 and 76 of each of the brick members 20, 24, 28, and 32 causes each of the brick members 20, 24, 28, and 32 to each appear as individual structures while still having an appearance of each being regular rectangular solid structures, i.e., appearing to have adjacent surfaces that are substantially mutually orthogonal to one another. It is noted that the first and second side surfaces 72 and 76 are depicted in the accompanying drawings as being oriented at an angle of about 4° with respect to one another, although it is noted that such a slightly nonparallel orientation with respect to one another can be achieved even if the first and second side surfaces 72 and 76 of the brick members are oriented with respect to one another at angles greater or lesser than 4°. The intersection of the front surface 64 and the rear surface 68 with each of the first and second side surfaces 72 and 76 is radiused as is indicated by the radius 100.

The non-parallel orientation of the first and second sides 72 and 76 results in tapering of the first and second sides 72 and 76 in two directions. That is, the first and second sides 72 and 76 are tapered toward one another both into the page of FIG. 7 (i.e., generally vertical with respect to FIG. 1) as well as in a direction leftward from the perspective of FIG. 7.

As can be understood from FIG. 1, by providing slight tapering in the vertical direction, the mere offsetting of the brick members 20, 24, 28, and 32 with respect to one another, whereby the second surfaces 68 are not coplanar and rather are spaced apart from one another, causes the brick members 20, 24, 28, and 32 to appear as individual bricks. Additional lateral tapering, that is, to the left in FIG. 7, further accentuates the appearance of individual bricks.

As is best shown in FIG. 3, each of the receptacles 44 includes and is defined by a first boss 104 and a second boss 108 that are axially aligned with one another. A pair of struts 112 (FIG. 7) extend between the first and second bosses 104 and 108 of each of the receptacles 44 and the side plates 56 to strengthen the receptacles 44. The first boss 104 includes an arcuate inner surface that defines a generally cylindrical cavity 116. The second boss 108 terminates at an annular ledge 120 that defines a terminus of the cavity 116. The second boss 108 is formed to include a channel 124 extending therethrough with the channel 124 including a circular portion 128 and a keyway portion 132. The circular portion 128 is axially aligned with the cavity 116. The keyway portion 132 is generally rectangular in cross section.

Each fastener 12 is generally in the form of a spike and includes an elongated shank 136 and a head 140. One end of the shank 136 terminates at a tip 144 that is pointed. The head 140 is disposed on the shank 136 at the end thereof opposite the tip 144. The pointed tip 144 facilitates insertion of the shank 136 into the grade 16 whereby the fastener 12 becomes engaged with the grade 16.

As is best shown in FIG. 5, the shank 136 includes a center post 148 and a plurality of ribs 152, with the ribs 152 being mounted on the center post 148 and extending radially outwardly therefrom.

The shank 136 additionally includes a first stop member 156 disposed on one of the ribs 152. The first stop member 156 is of substantially the same thickness as the rib 152 upon which it is mounted, but the first stop member 156 terminates at a first engagement surface 160 that is oriented substantially perpendicular with an axis 164 that is defined by the longitudinal extent of the shank 136.

The head 140 includes a first tab 168, a second tab 172, and a plurality of second stop members 176. The second stop members 176 are of substantially the same thickness as the ribs 152 and are disposed on the ribs 152 that do not have the first stop member 156 disposed thereon. The second stop members 176 each terminate at a second engagement surface 180, with the second engagement surfaces 180 all being disposed at a common axial location along the shank 136 that is positioned closer to the first and second tabs 168 and 172 than the first engagement surface 160. The second engagement surfaces 180 are each oriented substantially perpendicular to the axis 164.

The ribs 152 terminate at the first and second tabs 172. The first tab 168 includes a first head surface 184 defined thereon, and the second tab 172 includes a second head surface 188 defined thereon. The first and second head surfaces 184 and 188 intersect with one another at a head surface joint 192. The first and second head surfaces 184 and 188 are oriented with respect to one another at substantially the same angle as the front and rear surfaces 64 and 68 are oriented with respect to one another, meaning that in the depicted example the first and second head surfaces 184 and 188 are oriented generally perpendicular to one another.

It can further be seen that the first head surface 184 is oriented at an oblique angle with respect to the axis 164. As used herein, the expression “oblique” and variations thereof shall refer broadly to an orientation that is neither parallel with nor perpendicular to a reference. It similarly can be seen that the second head surface 188 is oriented oblique to the axis 164. The first and second head surfaces 184 and 188 are, however, oriented at different angles with respect to the axis 164. It is noted that the first and second head surfaces could be oriented at other non-oblique angles without departing from the concept of the present invention.

As indicated above and depicted generally in FIG. 4, the fasteners 12 are receivable in the receptacles 44 to mount the edging member 8 onto the grade 16. While the grade 16 may refer to a surface of the earth, it is understood that the grade 16 can be other surfaces and portions of structures without limitation. When the fastener 12 has been received to its fullest extent in the receptacle 44, it can be seen that the second engagement surfaces 180 of the second stop members 176 are engaged with the ledge 120. In this regard, the engagement of the second stop members 176 with the ledge 120 resists longitudinal movement of the fastener 12 in a direction toward the grade 16.

When the second stop members 176 are engaged with the ledge 120, the first stop member 156 is received in keyway portion 132. It can further be seen that in such position the first and second head surfaces 184 and 188 are aligned generally coplanar with the front and rear surfaces 64 and 68, respectively, and the head surface joint 192 is aligned with the member surface joint 80. It is noted that the front and rear surfaces 64 and 68 serve as member surfaces disposed on opposite sides of the member surface joint 80.

As suggested above, the first stop member 156 extends along the shank 136 to a position substantially closer to the tip 144 than the second stop members 176. As such, the second stop members 176 cannot become engaged with the ledge 120 unless the fastener is rotated to a specific rotational orientation with respect to the edging member 8 whereby the first stop member 156 is receivable in the keyway portion 132. If the fastener 12 is rotated to a different orientation with respect to the edging member 8, the first engagement surface 160 of the first stop member 156 will engage the ledge 120 instead of being received in the keyway portion 132, and thus will resist longitudinal movement of the fastener 12 in a direction toward the grade 16.

It thus can be seen that the first stop member 156 serves as a male engagement member that is receivable in the keyway portion 132, with the keyway portion 132 itself serving as a female engagement member to align the fastener 12 in a specific rotational orientation with respect to the edging member 8. Such alignment must occur before the fastener 12 can be fully received in the receptacle 44 with the second stop members 176 engaged with the ledge 120. Since the first and second head surfaces 184 and 188 are oriented at different oblique angles with respect to the axis 164 and are aligned coplanar with the front and rear surfaces 64 and 68, respectively, when the second stop members 176 are engaged with the ledge 120, the cooperation of the first stop member 156 with the keyway portion 132 ensures proper alignment of the head 140 with the brick member 20 or 28 prior to fully receiving the fastener 12 in the receptacle 44. Such a relationship facilitates mounting of the edging member 8 onto the grade 16 since the fasteners 12 thus are self aligning with respect to the edging member 8. In this regard, the distance between the ledge 120 and the base 14 may be slightly greater than the distance between the first engagement surface 160 and the tip 144 in order to permit rotation of the fastener 12 with respect to the edging member 8 prior to the shank 136 being engaged with the grade 16.

As can be seen in FIGS. 2 and 4, when the fastener 12 is fully received in the receptacle 44, the first and second head surfaces 184 and 188 are oriented substantially flush and coplanar with the front rear surfaces 64 and 68, respectively, in order to promote the appearance of the brick members 20 and 28 as being rectangular bricks. In such position, it can be seen that the head 140 is substantially received in the cavity 116. When the trim apparatus 4 is mounted on the grade 16 in such fashion, at least a portion of the edging member 8 is interposed between the head 140 and the grade 16.

In accordance with another aspect of the present invention, the exterior of the trim apparatus 4 is advantageously textured to simulate aged brick. Specifically, the front and rear surfaces 64 and 68, the first and second side surfaces 72 and 76, and the first and second head surfaces 184 and 188 include texturing formed thereon that simulates aged bricks. Such texturing may be formed during a process of molding the trim apparatus 4 or may be formed subsequent thereto. It is noted that such texturing is depicted by the exemplary stippled region 196 of FIG. 1. The texturing 196 thus further accentuates the appearance of the trim apparatus as including a plurality of individual aged bricks. The texturing may, for example, conform with the standard MT-1055-8 from MOLD-TECH of Salem, N.H., USA, although other types of texturing schemes may be employed without departing from the scope of the present invention.

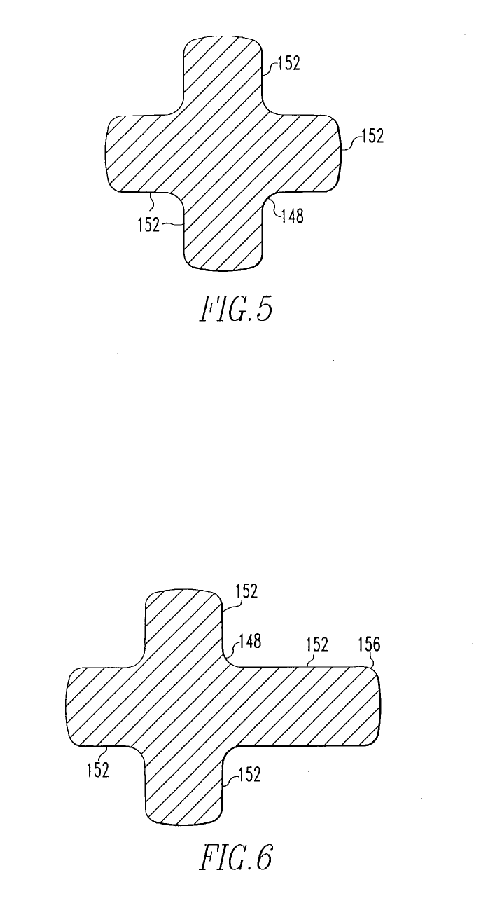

As can be seen in FIGS. 5 and 6, the shank 136 is substantially cross-shaped in cross section. FIG. 6 specifically depicts the additional dimension provided by the first stop member 56 to the rib 152 upon which the first stop member 156 is mounted. The cross-shaped cross section of the shank 136 depicted in FIG. 6 thus further illustrates that the shank 136 and thus the fastener 12 can be oriented only in a specific orientation with respect to the edging member 8 when the fastener 12 is fully received in the receptacle 44.

As can be understood from FIG. 7, while the first and second side surfaces 72 and 76 of any given brick member are oriented slightly nonparallel with one another, such nonparallel aspect is not readily visible to an observer since all of the first side surfaces 72 are parallel with one another, and all of the second side surfaces 76 are parallel with one another. Accordingly, an observer observing the trim apparatus 4 mounted on the grade 16 from any of a variety of angles generally will see surfaces that are parallel to one another, i.e., the first side surfaces 72 or the second side surfaces 76, as well as other surfaces that appear to be perpendicular to one another, i.e., the front and rear surfaces 64 and 68. Such a parallel nature of the first side surfaces 72 and of the second side surfaces 76, as well as the perpendicular nature of the front and rear surfaces 64 and 68 thus further accentuates the appearance of individual bricks while generally disguising the fact that the first and second side surfaces 72 and 76 actually are slightly nonparallel or tapered.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A trim apparatus structured to be mounted on a grade, the trim apparatus comprising:
an edging member including a receptacle formed therein, the edging member being structured to be disposed on the grade;
at least a first fastener, the at least first fastener including an elongated shank and a head, at least a portion of the shank being receivable in the receptacle, at least a portion of the shank being engageable with the grade to mount the trim apparatus on the grade whereby at least a portion of the edging member is interposed between the head and the grade;
the edging member including one of a male engagement member and a female engagement member disposed on the receptacle;
the shank including the other of the male engagement member and the female engagement member; and
the male and female engagement members being cooperable with one another to align the shank in a given rotational orientation in the receptacle with respect to the edging member when at least a portion of the shank is received in the receptacle.

2. The trim apparatus as set forth in claim 1, in which the head includes at least a first head surface, and in which the edging member includes at least a first member surface, the at least first head surface being alignable substantially flush with the at least first member surface when at least a portion of the at least first fastener is received in the receptacle.

3. The trim apparatus as set forth in claim 2, in which the at least first fastener includes one of a ledge and a stop member, and in which the edging member includes the other of a ledge and a stop member, the ledge and the stop member being engageable with one another, the ledge and the stop member being structured to resist longitudinal movement of the at least first fastener with respect to the edging member when the ledge and the stop member are engaged with one another.

4. The trim apparatus as set forth in claim 3, in which the at least first head surface is aligned substantially flush with the at least first member surface when the ledge and the stop member are engaged with one another.

5. The trim apparatus as set forth in claim 3, in which the shank includes a center post and a plurality of alignment ribs, the alignment ribs extending radially outwardly from the post.

6. The trim apparatus as set forth in claim 5, in which the stop member is disposed adjacent at least one of the alignment ribs.

7. The trim apparatus as set forth in claim 6, in which the male engagement member is disposed on one of the alignment ribs.

8. The trim apparatus as set forth in claim 5, in which at least a portion of the shank is generally cross-shaped in cross section.

9. The trim apparatus as set forth in claim 2, in which the at least first head surface is oriented generally oblique to an axis defined by the longitudinal extent of the shank.

10. The trim apparatus as set forth in claim 2, in which the head includes a second head surface adjacent the first head surface, and in which the edging member includes a second member surface adjacent the at least first member surface, the at least first and second head surfaces being alignable substantially flush with the at least first and second member surfaces when at least a portion of the at least first fastener is received in the receptacle.

11. The trim apparatus as set forth in claim 1, in which the edging member includes a plurality of brick members, each brick member including a pair of opposed surfaces that are spaced apart from one another and oriented nonparallel with one another, whereby at a region of juncture between adjoining brick members the opposed surfaces of one adjoining brick member are spaced closer to one another than the pair of opposed surfaces of the other adjoining brick member.

12. The trim apparatus as set forth in claim 11, in which the brick members are aligned with one another.

13. The trim apparatus as set forth in claim 12, in which one of the opposed surfaces of the brick members are oriented substantially parallel with one another, and in which the other of the opposed surfaces of the brick members are oriented substantially parallel with one another.

14. The trim apparatus as set forth in claim 1, in which the receptacle includes a recessed cavity, the head being receivable in the cavity.

15. The trim apparatus as set forth in claim 1, in which the edging member includes texturing formed on at least a portion of the edging member.

16. A trim apparatus structured to be mounted on a grade, the trim apparatus comprising:
an edging member including a pair of member surfaces and a receptacle, the edging member including a member surface joint formed generally by an intersection of the pair of member surfaces, the receptacle being disposed generally at the member surface joint, the edging member being structured to be disposed on the grade;
at least a first fastener, the at least first fastener including an elongated shank and a head, at least a portion of the at least first fastener being receivable in the receptacle, the at least first fastener received in the receptacle being engageable with the grade to retain the edging member on the grade;
the head including a pair of head surfaces that intersect with one another to form a head surface joint; and
the head surfaces being alignable substantially flush with the member surfaces and the head surface joint being alignable substantially flush with the member surface joint when at least a portion of the at least first fastener is received in the receptacle.

17. The trim apparatus as set forth in claim 16, in which the at least first fastener includes one of a ledge and a stop member, and in which the edging member includes the other of the ledge and the stop member, the ledge and the stop member being engageable with one another, the ledge and the stop member being structured to resist longitudinal movement of the at least first fastener with respect to the edging member when the ledge and the stop member are engaged with one another.

18. The trim apparatus as set forth in claim 17, in which the head surfaces are aligned substantially flush with the member surfaces and the head surface joint is aligned substantially flush with the member surface joint when the ledge and the stop member are engaged with one another.

19. The trim apparatus as set forth in claim 17, in which the edging member includes one of a male engagement member and a female engagement member disposed on the receptacle, the shank including the other of the male engagement member and the female engagement member, the male and female engagement members being cooperable with one another to align the shank in a given rotational orientation in the receptacle with respect to the edging member when at least a portion of the shank is received in the receptacle.

20. The trim apparatus as set forth in claim 19, in which the shank includes a center post and a plurality of alignment ribs, the alignment ribs extending radially outwardly from the post.

21. The trim apparatus as set forth in claim 20, in which the stop member is disposed adjacent at least one of the alignment ribs.

22. The trim apparatus as set forth in claim 21, in which the male engagement member is disposed on one of the alignment ribs.

23. The trim apparatus as set forth in claim 20, in which at least a portion of the shank is generally cross-shaped in cross section.

24. The trim apparatus as set forth in claim 19, in which the head surfaces are each oriented generally oblique to an axis defined by the longitudinal extent of the shank.

25. The trim apparatus as set forth in claim 24, in which one of the head surfaces is oriented at a first angle oblique to the axis, and in which the other of the head surfaces is oriented at a second angle oblique to the axis, the first and second angles being unequal.

26. The trim apparatus as set forth in claim 16, in which the edging member includes a plurality of brick members, each brick member including a pair of opposed surfaces that are spaced apart from one another and oriented nonparallel with one another, whereby at a region of juncture between adjoining brick members the opposed surfaces of one adjoining brick member are spaced closer to one another than the pair of opposed surfaces of the other adjoining brick member.

27. The trim apparatus as set forth in claim 26, in which the brick members are aligned with one another.

28. The trim apparatus as set forth in claim 27, in which one of the opposed surfaces of the brick members are oriented substantially parallel with one another, and in which the other of the opposed surfaces of the brick members are oriented substantially parallel with one another.

29. The trim apparatus as set forth in claim 16, in which the receptacle includes a recessed cavity, the head being receivable in the cavity.

30. The trim apparatus as set forth in claim 16, in which the edging member includes texturing formed on at least a portion of the edging member.
